(19) United States
(12) Patent Application Publication
(10) Pub. No.: US 2021/0239482 A1
(43) Pub. Date: Aug. 5, 2021

(54) INFORMATION PROCESSING APPARATUS, INFORMATION PROCESSING METHOD, AND SYSTEM

(71) Applicant: TOYOTA JIDOSHA KABUSHIKI KAISHA, Toyota-shi (JP)

(72) Inventors: Tatsuya MATSUNAMI, Nisshin-shi (JP); Atsuko YAMANAKA, Toyota-shi (JP); Kunihiro TSUNEKAWA, Toyota-shi (JP); Sokfan YEE, Toyota-shi (JP); Masahiro TANAKA, Toyota-shi (JP); Shuichiro TAKAHASHI, Okazaki-shi (JP); Satoshi NONOYAMA, Toyota-shi (JP); Tokuyuki NISHIKAWA, Toyota-shi (JP); Hikaru SATOU, Okazaki-shi (JP)

(73) Assignee: TOYOTA JIDOSHA KABUSHIKI KAISHA, Toyota-shi (JP)

(21) Appl. No.: 17/164,119

(22) Filed: Feb. 1, 2021

(30) Foreign Application Priority Data
Jan. 30, 2020 (JP) 2020-013523

(51) Int. Cl. G01C 21/34; B60W 60/00; G01C 21/36

(52) U.S. Cl. CPC G01C 21/3484; G06F 3/14; G01C 21/3635; B60W 60/0013

(57) ABSTRACT

The present disclosure makes it possible to suitably provide a smoking space for smokers. A controller 204 of an information processing apparatus, which is a server apparatus 200 of the present disclosure, performs estimating smoking demand based on past smoking-related information on a plurality of users. The controller 204 performs generating a travel plan for a vehicle including a smoking space based on the estimated smoking demand.

### CROSS REFERENCE TO THE RELATED APPLICATION

This application claims the benefit of Japanese Patent Application No. 2020-013523, filed on Jan. 30, 2020, which is hereby incorporated by reference herein in its entirety.

### BACKGROUND

### Technical Field

The present disclosure relates to an information processing apparatus, an information processing method, and a system.

### Description of the Related Art

Japanese Patent Laid-Open No. 2001-180596 proposes to partition the interior of transportation means such as an airplane, a train, and a bus using wall bodies to form a smoking room in the transportation means.

### CITATION LIST

### Patent Document

Patent document 1: Japanese Patent Laid-Open No. 2001-180596

### SUMMARY

One or more aspects of the present disclosure are directed to make it possible to suitably provide a smoking space for smokers.

One aspect of an embodiment of the present disclosure may be exemplified by an information processing apparatus comprising a controller. The controller may perform: estimating smoking demand based on past smoking-related information on a plurality of users; and generating a travel plan for a vehicle including a smoking space based on the estimated smoking demand. Another aspect of an embodiment of the present disclosure may be also exemplified by an information processing method executed by at least one computer of the information processing apparatus described above and the like. Furthermore, yet another aspect of an embodiment of the present disclosure may be also exemplified by a program to be executed by at least one computer of the information processing apparatus described above and the like, and a non-transitory storage medium in which the program is recorded.

According to this information processing apparatus, it is possible to suitably provide a smoking space for smokers.

### BRIEF DESCRIPTION OF THE DRAWINGS

FIG. 1 is a conceptual diagram of a system according to an embodiment of the present disclosure;

FIG. 2 is a block diagram schematically illustrating the configuration of the system in FIG. 1, especially the configuration of a traveling unit;

FIG. 3 is a block diagram schematically illustrating the configuration of the system in FIG. 1, especially the configuration of a server apparatus;

FIG. 4 is a block diagram schematically illustrating the configuration of the system in FIG. 1, especially the configuration of a user apparatus;

FIG. 5A, FIG. 5B and FIG. 5C are diagrams for describing smoking histories of a plurality of users in the system in FIG. 1;

FIG. 6A, FIG. 6B and FIG. 6C are diagrams for describing cigarette purchase histories of the plurality of users in the system in FIG. 1; and

FIG. 7 is a flowchart in a controller of the server apparatus in the system in FIG. 1.

### DESCRIPTION OF THE EMBODIMENTS

An information processing apparatus according to an embodiment of the present disclosure, an information processing method in a controller in the information processing apparatus, and a system will be described below with reference to the drawings.

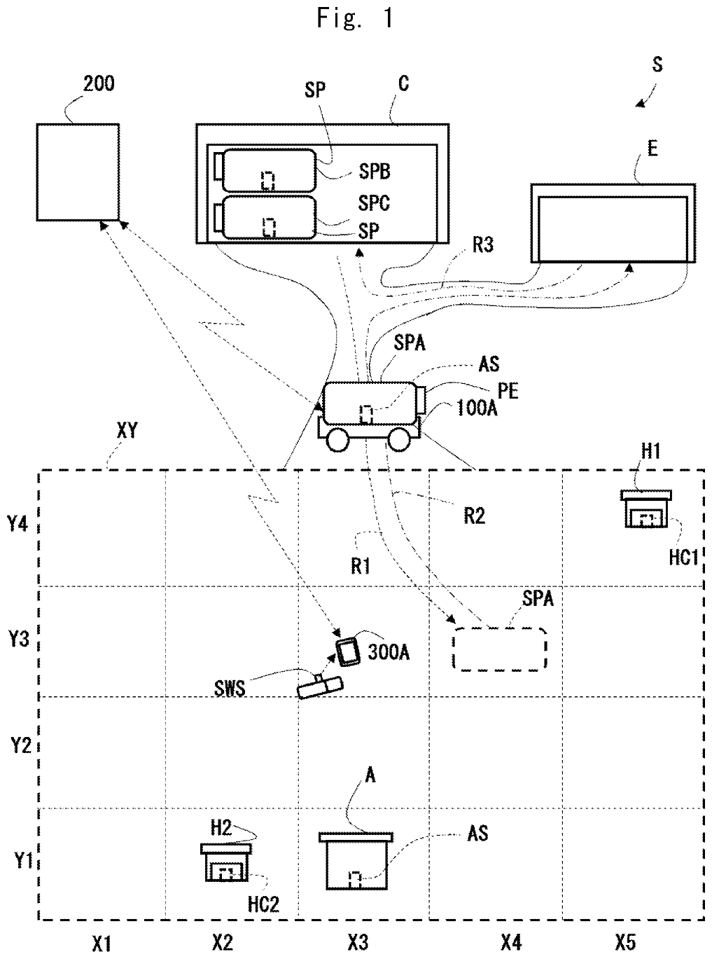

FIG. 1 conceptually illustrates a system S for providing a smoking space according to an embodiment of the present disclosure. FIG. 1 conceptually illustrates one scene in the system S.

The system S has traveling units 100 (100A, . . . ), a server apparatus 200, and user apparatuses 300 (300A, . . . ). Note that in FIG. 1, a standby place for smoking units SP (SPA, SPB, SPC . . . ) and a standby place for the traveling units 100 are integrated into a center C. Then, the server apparatus 200 is positioned away from the center C. However, the standby place for the smoking units SP and the standby place for the traveling units 100 may be provided separately. The server apparatus 200 may be provided in the center C. At least one of the user apparatuses 300 (300A, . . . ) and the server apparatus 200 illustrated in FIG. 1 are an example of the system of the present disclosure. However, the system of the present disclosure may be a plurality of user apparatuses 300 (300A, . . . ) and the server apparatus 200. The system of the present disclosure can collect smoking-related information from at least one user apparatus 300.

Here, a traveling unit 100 is a moving body capable of traveling based on an operational command from the server apparatus 200. The server apparatus 200 is an information processing apparatus, and is a computer on a network N. The server apparatus 200 is configured to be communicable with each of the traveling units 100 via the network N, and cooperates with an information processing apparatus 102 of the traveling unit 100 via the network N. Note that, for example, only the traveling unit 100A of the plurality of traveling units 100 (100A, . . . ) is exemplified in FIG. 1. However, this is not intended to limit the number of the traveling units 100, but there may be one or more or any number of traveling units.

The server apparatus 200 is communicable with other server apparatuses and the like via the network N. The server apparatus 200 is also configured to be communicable with each of the user apparatuses 300 via the network N in addition to being configured to be communicable with each of the traveling units 100.

A user apparatus 300 is configured to be communicable with the server apparatus 200 via the network N. For example, only the user apparatus 300A of the plurality of user apparatuses 300 (300A, . . . ) is exemplified in FIG. 1. However, this is not intended to limit the number of the user apparatuses, but there may be any number of user apparatuses.

A traveling unit 100 is a kind of autonomous traveling vehicle here, and is also called an electric vehicle (EV) pallet. The traveling unit 100 is configured as a moving body capable of automatic driving and unmanned driving. In the system S, the traveling unit 100 can have various dimensions and various configurations. Note that the traveling unit 100 may further be configured to enable a person to get thereon/thereoff. The traveling unit 100 may not necessarily be a vehicle capable of completely autonomous travel. For example, the traveling unit 100 may be a vehicle that a person drives or assists in driving.

Here, the server apparatus 200 is, for example, an apparatus that commands a traveling unit 100 to operate. For example, the server apparatus 200 provides, or transmits, an operational command including a travel plan for a traveling unit 100 to the traveling unit 100.

Each component in the system S in FIG. 1 will be described below in detail. First, a traveling unit 100 and a smoking unit SP will be described.

The traveling unit 100 is capable of traveling by itself, and is configured to detachably, or separably, connecting the smoking unit SP thereto. In FIG. 1, the smoking unit SPA is placed on top of the traveling unit 100A and connected thereto. Note that the smoking unit SPA is not limited to having a form of being placed on and connected to the traveling unit 100, for example, may be a unit towed by the traveling unit 100.

Each of the smoking units SP (SPA, . . . ) is provided with a smoke treatment apparatus PE. As for the smoking units SP, the configurations of the smoke treatment apparatus PE and the like associated with the smoking unit SPA among them will be described below. The same applies to the other smoking units SP (SPB, . . . ).

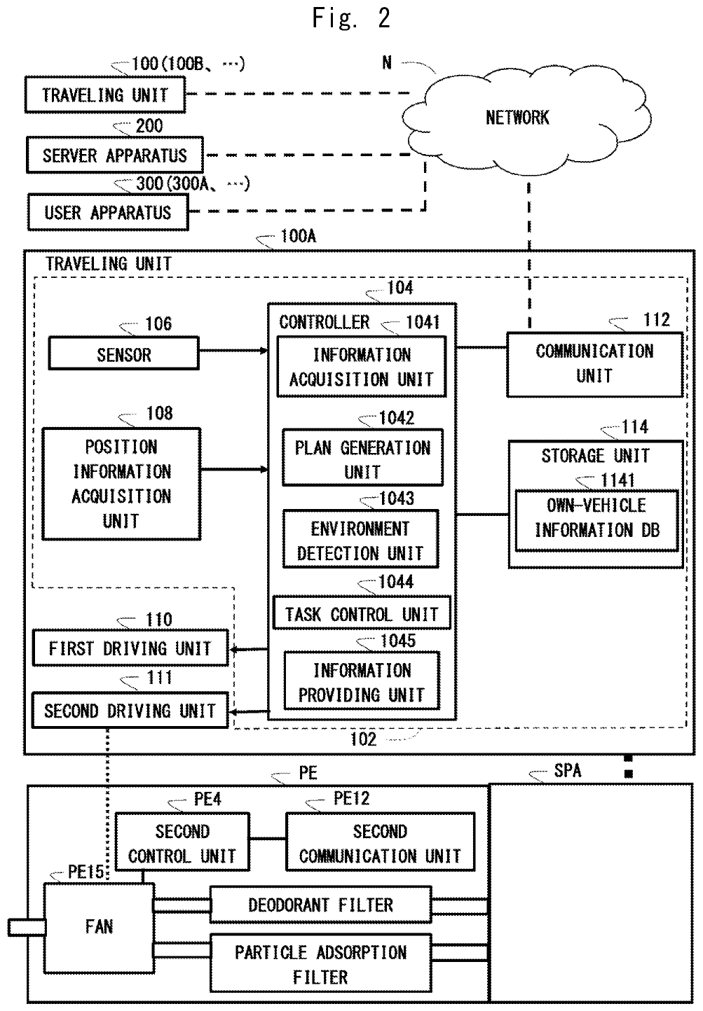

The smoke treatment apparatus PE sucks air containing smoke from the vehicle interior space of the smoking unit SPA to suck particles of smoke as well as to deodorize cigarette odor, thereby purifying the air containing smoke as much as possible. The purified air can be exhausted outside the smoking unit SPA in a predetermined region when the level of the purification satisfies a predetermined criterion. Sucking air containing smoke to suck particles of smoke as well as to deodorize cigarette odor will be referred to as smoke treatment. However, depending on regions, a region is also assumed where exhaust of air sucked from the vehicle interior space of the smoking unit SPA is prohibited even when it is purified air. So, the server apparatus 200 manages exhaust of smoke based on position information, exhaust standards for cigarette smoke or the like in a region indicated by the position information, and a degree of purification of smoke. The degree of purification of smoke is determined from, for example, the ability of the smoke treatment apparatus PE (see FIG. 2).

The smoking unit SPA has an in-vehicle space as a cabin which a user who is a smoker can get in for smoking a cigarette, that is, a smoking space. An ashtray AS is installed in the smoking space inside the smoking unit SP. In a state where the smoking unit SP is connected, the traveling unit 100 can also travel with users getting thereon, or the traveling unit 100 can separate the smoking unit SP and install it somewhere to provide a smoking space.

Then, FIG. 2 is a block diagram schematically illustrating the configuration of the system S including the traveling units 100, the server apparatus 200, and the user apparatuses 300. FIG. 2 especially exemplifies the respective details of the configuration of the traveling unit 100A and the configuration of the smoking unit SPA connected thereto. Although the smoking unit SPA and the traveling unit 100A are exemplified in one-to-one relationship in FIG. 2, the smoking unit SP and the traveling unit 100A may not have one-to-one relationship in the system S. For example, one traveling unit 100A may be associated with a plurality of smoking units SP.

As illustrated in FIG. 2, the smoking unit SPA is provided with the smoke treatment apparatus PE. The smoke treatment apparatus PE has a second control unit PE4, a second communication unit PE12, a fan PE15, a deodorant filter, a particle adsorption filter, and a pipe connecting the smoking space in the smoking unit SPA through the deodorant filter, the particle adsorption filter, and the fan PE15 to the outdoors. However, the second control unit PE4 and the second communication unit PE12 may be provided in the smoking unit SPA to control the overall smoking unit SPA rather than being dedicatedly installed in the smoke treatment apparatus PE. The function of the second communication unit PE12 is the same as that of a communication unit 112. The second control unit PE4 performs smoke treatment according to a smoke treatment plan or a smoke treatment command acquired from the server apparatus 200 via the communication unit 112 of the traveling unit 100A, and performs processing for exhausting air containing the treated smoke.

For example, when the second control unit PE4 receives an instruction to perform smoke treatment from the server apparatus 200 via the second communication unit PE12, the second control unit PE4 performs smoke treatment and exhaust processing according to the received instruction. In this case, the second control unit PE4 performs smoke treatment according to the smoke treatment plan, and performs processing for exhausting air containing the treated smoke. However, when the traveling unit 100A is connected to the smoking unit SPA, a second driving unit 111 of the traveling unit 100A may drive the fan PE15 of the smoke treatment apparatus PE. When the communication unit 112 of the traveling unit 100A is communicable with the second communication unit PE12 of the smoke treatment apparatus PE, a control unit 104 of the traveling unit 100A may perform the processing instead of the server apparatus 200. For example, the control unit 104 may instruct the second control unit PE4 of the smoke treatment apparatus PE to perform smoke treatment and exhaust processing.

FIG. 2 illustrates the configuration of the traveling unit 100A as an example of the traveling units 100. The other traveling units 100 (100B, . . . ) are also provided with the configuration described below, for example, the information processing apparatus 102.

The traveling unit 100A in FIG. 2 is provided with the intonation processing apparatus 102, and has the control unit 104 that practically takes on its function. The traveling unit 100A can, for example, travel according to an operational command acquired from the server apparatus 200. Specifically, the traveling unit 100A travels in a suitable manner based on an operational command acquired via the network N while sensing the periphery of the vehicle. Then, as a result of this travel, the traveling unit 100A can provide various users with a smoking space.

The traveling unit 100A is configured to further include a sensor 106, a position information acquisition unit 108, a first driving unit 110, the second driving unit 111, the communication unit 112, and a storage unit 114. The traveling unit 100A operates with electric power supplied from a battery.

The sensor 106 is means for sensing the periphery of the vehicle, and typically includes a stereo camera, a laser scanner, light detection and ranging, laser imaging detection and ranging (LIDAR), a radar, and the like. Information acquired by the sensor 106 is transmitted to the control unit 104. The sensor 106 includes a sensor for its own vehicle to travel autonomously. The sensor 106 includes a camera provided on the vehicle body of the traveling unit 100A. For example, the camera may be an image capturing device using an image sensor such as charged-coupled devices (CCD), metal-oxide-semiconductor (MOS), or complementary metal-oxide-semiconductor (CMOS).

The position information acquisition unit 108 is means for acquiring the current position of the traveling unit 100A. The position information acquisition unit 108 is configured to include a global positioning system (GPS) receiver. The GPS receiver as a satellite signal receiver receives a signal from a plurality of GPS satellites. Each GPS satellite is an artificial satellite that circles the earth. A satellite positioning system, that is, a navigation satellite system (NSS) is not limited to GPS. Position information may be detected based on signals from various satellite positioning systems. NSS is not limited to the global navigation satellite system, may include a quasi-zenith satellite system such as Galileo in Europe and “Michibiki” in Japan, which is operated integrally with GPS. Note that the position information acquisition unit 108 may include a receiver that receives radio waves from a transmitter such as a beacon. In this case, it is preferable that a plurality of transmitters are arranged by the roadside or the like, and regularly emit radio waves at a specific frequency and/or in a specific signal format. Note that the position information detection system provided with the position information acquisition unit 108 is not limited to these techniques.

The control unit 104 is a computer that controls the traveling unit 100A based on information acquired from the sensor 106, the position information acquisition unit 108, and the like. The control unit 104 is an example of control means for controlling the travel of the traveling unit 100A, the work of connecting and separating the smoking unit SP to and from the traveling unit, and the like.

The control unit 104 has a CPU and a main memory unit, and executes information processing using a program. The CPU is also called a processor. The main memory unit of the control unit 104 is an example of the main memory. The CPU in the control unit 104 executes a computer program loaded into its main memory unit in an executable manner to provide various functions. The main memory unit in the control unit 104 stores, for example, computer programs executed by the CPU and/or data. The main memory unit in the control unit 104 is a dynamic random access memory (DRAM), a static random access memory (SRAM), a read only memory (ROM), or the like.

The control unit 104 is connected to the storage unit 114. The storage unit 114 is a so-called external storage unit, is used as a storage area that supplements the main memory unit of the control unit 104, and stores, for example, computer programs executed by the CPU of the control unit 104 and/or data. The storage unit 114 is a hard disk drive, a solid state drive (SSD), or the like.

The control unit 104 has an information acquisition unit 1041, a plan generation unit 1042, an environment detection unit 1043, a task control unit 1044, and an information providing unit 1045 as functional modules. Each functional module is implemented by executing a program stored in the main memory unit and/or the storage unit 114 using the control unit 104, that is, the CPU therein.

The information acquisition unit 1041 acquires information such as an operational command including a travel plan from the server apparatus 200. The operational command may include information on connection and separation of the smoking unit SP in its traveling unit 100A. The information acquisition unit 1041 regularly or irregularly acquires information on its own vehicle, and stores it in an own-vehicle information database 1141 in the storage unit 114.

The plan generation unit 1042 generates an operational plan for its own vehicle based on the operational command acquired from the server apparatus 200, especially based on information on the travel plan included therein. Note that the operational plan generated by the plan generation unit 1042 is transmitted to the task control unit 1044 described later. In this embodiment, an operational plan refers to data that specifies a route to be traveled by the traveling unit 100A, a scheduled date and time at each point on the route, and processing that should to be performed by the traveling unit 100A on a part or all of the route. Examples of the data included in the operational plan include, for example, the following:

(1) Data in which a Route to be Traveled by the Own Vehicle is Represented by a Set of Road Links

The route to be traveled by the own vehicle may be generated automatically, for example, with reference to map data stored in the storage unit 114, based on information in the travel plan included in the operational command, and based on a given point of departure and destination. The route may be generated by utilizing external services.

(2) Data that Represents Processing that should to be Performed by the Own Vehicle at a Point on the Route

Although the processing that should to be performed by the own vehicle on the route includes, for example, connection and/or separation of the smoking unit SP, it is not limited thereto.

The environment detection unit 1043 detects the environment around the vehicle based on data acquired by the sensor 106. Although objects to be detected include, for example, the number and positions of lanes, the number and positions of vehicles that are present around the own vehicle, the number and positions of obstacles (e.g., pedestrians, bicycles, structures, and buildings) that are present around the own vehicle, road structure, and road signs, they are not limited thereto. An object to be detected may be anything as long as it is an object that is required to travel autonomously. The environment detection unit 1043 may track a detected object. For example, the relative velocity of an object may be calculated from the difference between the coordinate of the object detected one step before and the current coordinate of the object. Data regarding the environment (hereinafter referred to as environmental data) that is detected by the environment detection unit 1043 is transmitted to the task control unit 1044 described later.

The task control unit 1044 controls the activation of the first driving unit 110 for its own vehicle and the activation of the second driving unit 111 based on the operational plan generated by the plan generation unit 1042, the environmental data generated by the environment detection unit 1043, and the position information of its own vehicle acquired by the position information acquisition unit 108. For example, the task control unit 1044 causes its own vehicle to travel so that it travels along a predetermined route and obstacles do not enter a predetermined safety area around its own vehicle. A well-known method can be employed as a method for causing the vehicle to travel autonomously. The task control unit 1044 also executes tasks other than traveling based on the operational plan generated by the plan generation unit 1042. Tasks can include the work of connecting and/or separating the smoking unit SP, and various activations of the smoke treatment apparatus PE of the connected smoking unit SP.

The information providing unit 1045 provides, or transmits, information on its own vehicle to the server apparatus 200. This provision may be performed regularly or irregularly.

The first driving unit 110 is means for causing the traveling unit 100A to travel based on a command generated by the task control unit 1044. The first driving unit 110 is configured to include, for example, a motor for driving wheels, an inverter, brakes, a steering mechanism, and a secondary battery.

The second driving unit 111 is means for causing each work of connecting and/or separating the smoking unit SP to be performed based on a command generated by the task control unit 1044. Furthermore, the second driving unit 111 may be means for causing, for example, smoke suction processing by the smoke treatment apparatus PE when the smoking unit SP is connected and/or smoke exhaust processing to the outside of the smoking unit SP through the smoke treatment apparatus PE to be performed based on a similar command. The second driving unit 111 may be configured to include a hydraulic mechanism or a motor for activation of a connection mechanism and the like.

The communication unit 112 has communication means for connecting the traveling unit 100A to the network N. In this embodiment, the traveling unit 100A can communicate with another apparatus, for example, the server apparatus 200 via the network N. Note that the communication unit 112 may further have communication means for the traveling unit 100A, which is its own vehicle, to perform inter-vehicle communication with other traveling units 100 (100B, . . . ).

Next, the server apparatus 200 will be described. The server apparatus 200 is an apparatus that provides information on various operational commands to each of the plurality of traveling units 100.

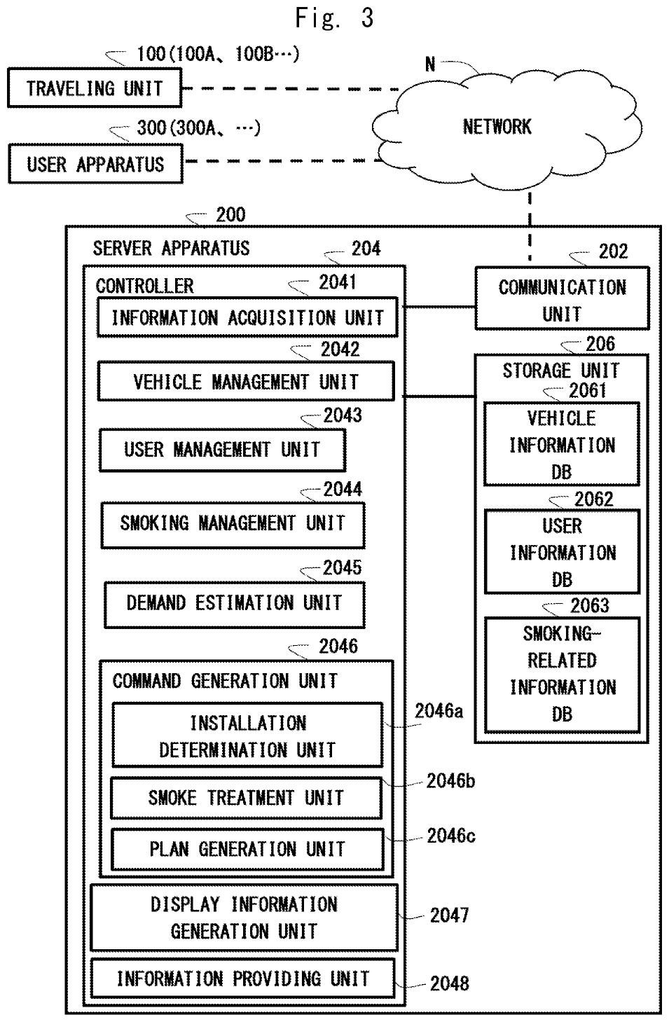

The server apparatus 200 is an information processing apparatus, and is configured to have a communication unit 202, a control unit 204, a storage unit 206 as illustrated in FIG. 3. The communication unit 202 is the same as the communication unit 112, and has a communication function for connecting the server apparatus 200 to the network N. Then, the communication unit 202 of the server apparatus 200 is a communication interface for communicating with the traveling unit 100 and the user apparatus 300 via the network N. The control unit 204 has a CPU and a main memory unit as in the control unit 104, and executes information processing using a program. Of course, this CPU is also a processor, and the main memory unit of the control unit 204 is also an example of a main memory. The CPU in the control unit 204 executes a computer program loaded into its main memory unit in an executable manner to provide various functions. The main memory unit in the control unit 204 stores, for example, computer programs executed by the CPU and/or data. The main memory unit in the control unit 204 is a DRAM, an SRAM, a ROM, or the like.

The control unit 204 is connected to the storage unit 206. The storage unit 206 is an external storage unit, is used as a storage area that supplements the main memory unit of the control unit 204, and stores, for example, computer programs executed by the CPU of the control unit 204 and/or data. The storage unit 206 is a hard disk drive, an SSD, or the like.

The control unit 204 is means for controlling the server apparatus 200. As illustrated in FIG. 3, the control unit 204 has an information acquisition unit 2041, a vehicle management unit 2042, a user management unit 2043, a smoking management unit 2044, a demand estimation unit 2045, a command generation unit 2046, a display information generation unit 2047, and an intonation providing unit 2048 as functional modules. Although the command generation unit 2046 includes an installation determination unit 2046a, a smoke treatment unit 2046b, and a plan generation unit 2046c, one, some, or all of them may be provided outside the command generation unit 2046. Each of these functional modules is implemented by executing a program stored in the main memory unit and/or the storage unit 206 using the CPU of the control unit 204.

The information acquisition unit 2041 acquires various kinds of information from the traveling unit 100 and the user apparatus 300. Then, the acquired information is transmitted to the vehicle management unit 2042, the user management unit 2043, the smoking management unit 2044, and the like. The information acquisition unit 2041, for example, regularly acquires the position information, information in the own-vehicle information database 1141, and the like from the traveling unit 100, and transmits them to the vehicle management unit 2042. Furthermore, the information acquisition unit 2041 acquires information on a plurality of registered users or information entered by the users from the user apparatuses 300 associated with the users, and transmits it to the user management unit 2043. The information acquisition unit 2041 acquires, as smoking-related information on the plurality of registered users, smoking histories and cigarette purchase histories of the plurality of users from the user apparatuses 300 and computers HC1 and HC2 at respective stores H1 and H2, and transmits them to the smoking management unit 2044. Note that although FIG. 1 illustrates only two stores H1 and H2 as stores carrying cigarettes and depicts only two computers HC1 and HC2 therein, the number of them may be zero, one, or three or more.

The vehicle management unit 2042 manages information on a plurality of traveling units 100 under management. Specifically, the vehicle management unit 2042 receives, from the plurality of traveling units 100, information such as data regarding the traveling units 100 via the information acquisition unit 2041, and stores it in a vehicle information database 2061 of the storage unit 206. Position information and vehicle information are used as information on a traveling unit 100. The vehicle information is, for example, an identifier, a use and type, information on a standby point, a travelable distance, and current status of the traveling unit 100. The vehicle management unit 2042 also stores position information and unit information of the smoking unit SP in the vehicle information database 2061 of the storage unit 206. Information on a position of connection and/or separation from the traveling unit 100 is used as the position information of the smoking unit SP. The unit information of the smoking unit SP includes the size, the riding capacity, and the like of the smoking unit SP, and is here acquired by entering it from an operation terminal of an operator or the user apparatuses 300.

The user management unit 2043 stores information on the users in a user information database 2062 of the storage unit 206. When information from the user is acquired via the information acquisition unit 2041, the user management unit 2043 stores the information in the user information database 2062. The user information database 2062 stores user information. The user information includes information specific to a user (e.g., a user ID and a contact).

The smoking management unit 2044 stores the smoking-related information acquired via the information acquisition unit 2041 in a smoking-related information database 2063 of the storage unit 206. Although the smoking-related information is smoking histories and cigarette purchase histories of a plurality of users here, it may be information including at least any one of them. The smoking histories of the plurality of users have position information and time information of smoking. Here, an electronic cigarette of a user is provided with a sensing device SWS for sensing the activation, for example, the press of its switch. When the sensing device SWS (see FIG. 1) senses the activation of the switch of the electronic cigarette, the detection signal is transmitted to the user apparatus 300 of its user. Since an application 3061 described later is introduced in the user apparatus 300, a signal indicating the reception of the detection signal is transmitted to the server apparatus 200 together with its own position information as information indicating a smoking location. In FIG. 1, the user apparatus of a user who is a smoker of an electronic cigarette is the user apparatus 300A. Cigarette purchase histories of a plurality of users have position information and time information of purchase of cigarettes. Here, the computers HC1 and HC2 in the stores H1 and H2 can sense that the user of the user apparatus 300 is a registered user in association with electronic payment processing on the user apparatus 300 in purchasing cigarettes. In the case of a registered user, the computers HC1 and HC2 transmit store information (e.g., a store ID) to the server apparatus 200 as information on purchase of cigarettes. Note that the server apparatus 200 can store the time of reception of the signal from the user apparatus 300 as time information of a smoking history. The server apparatus 200 can store the time of reception of the signal from the computers HC1 and HC2 as time information of a cigarette purchase history. When receiving the signal from the user apparatus 300, the server apparatus 200 can confirm whether the user of the user apparatus 300 is a registered user or not based on the user information (e.g., the user ID) accompanying the signal.

The demand estimation unit 2045 estimates smoking demand based on the smoking-related information in the smoking-related information database 2063. Estimation of smoking demand includes estimation of time periods and locations having the possibility of smoking. This is performed based on a predetermined program, data, and the like. The possibility of smoking can also be called demand for smoking. Further, the possibility of smoking can be called the possibility of demand for smoking. This is because smoking demand or desire for smoking may be estimated even in the case of not smoking actually.

The command generation unit 2046 generates a travel plan for a vehicle having a smoking space based on the estimated smoking demand, and generates an operational command including the travel plan. A vehicle having a smoking space refers to a traveling unit 100 to which a smoking unit SP provided with a smoking space may be connected. Note that a vehicle having a smoking space may be provided with a smoking unit SP not in a separable manner but in an inseparable and integrated manner.

The installation determination unit 2046a in the command generation unit 2046 determines in which time period a smoking unit SP, that is, a smoking space is installed at one or a plurality of locations among the estimated time periods and locations having demand for smoking. For example, when an estimated location having demand for smoking has an existing smoking facility, it is not determined to install a smoking unit SP at the location. When another smoking unit SP has been installed, installation of a further smoking unit SP within a predetermined range therefrom may be excluded.

When providing a smoking space using the smoking unit SP to allow for smoking, the smoke treatment unit 2046b in the command generation unit 2046 determines where to treat air containing smoke sucked by the smoke treatment apparatus PE provided therein and/or purified air. Specifically, the smoke treatment unit 2046b determines when and where the air may be exhausted outside the vehicle. This determined smoke treatment plan is also included in an operational command for the traveling unit 100. Here, it may be determined to perform smoke treatment in a treatment site E in FIG. 1. This is because a predetermined condition permitting smoke exhaust is satisfied only in the treatment site E in this embodiment.

The plan generation unit 2046c in the command generation unit 2046 generates a travel plan for performing the installation of a smoking unit SP at a location and in a time period that are determined by the installation determination unit 2046a, and the smoke exhaust processing in the treatment site E determined by the smoke treatment unit 2046b. Although this travel plan includes a separation position and separation time of the smoking unit SP from the traveling unit 100 and a retrieval time at which the separated smoking unit SP is connected to the traveling unit 100, a part thereof may be omitted, or further information may be appended. Then, the plan generation unit 2046c transmits information including the generated travel plan to the information providing unit 2048 as an operational command.

In order to enable information on when and where a smoking unit SP is installed based on the travel plan generated by the command generation unit 2046 to be displayed on the user apparatus 300, the display information generation unit 2047 generates information therefor. The display information generation unit 2047 generates information enabling a current arrangement map of smoking units SP provided with a smoking space to be displayed on the user apparatus 300 of a user. For example, it is information enabling a map of an area XY in FIG. 1 described later to be displayed on the user apparatus 300. This information may include, for example, the arrangement of installed smoking units SP and/or the arrangement of smoking units SP to be installed and their installation times. The display information generation unit 2047 generates information specifying a scheduled date and time at which a smoking unit SP provided with a smoking space is arranged at a position within a predetermined range from the position of the user apparatus 300 of the user. This information may be, for example, information for displaying a position where a smoking unit SP is scheduled to be arranged and the date and time at which the arrangement is scheduled together with the position of the corresponding user apparatus 300 or the like in the map of the area XY in FIG. 1. Note that at least any one of the information enabling the current arrangement map to be displayed and the information specifying the scheduled date and time as described above may be enabled to be displayed.

The information providing unit 2048 provides, or transmits, an operational command including the travel plan generated by the command generation unit 2046 to a predetermined traveling unit 100. The information providing unit 2048 provides, or transmits, the information generated by the display information generation unit 2047 to the user apparatus 300. Here, it is provided to the user apparatus 300 so that a display of the information can be displayed on an activated screen of the application 3061 of the user apparatus 300.

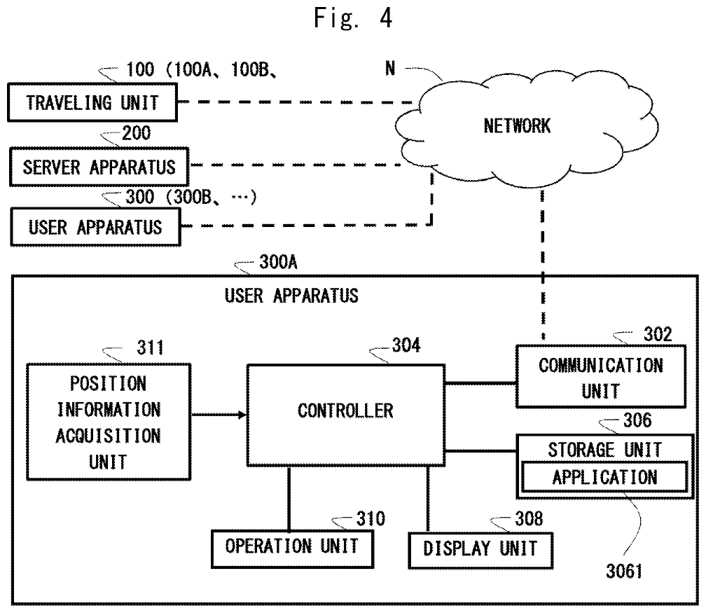

Next, the user apparatus 300 will be described. The user apparatus 300 is, for example, a mobile terminal, a smartphone, a personal computer, or the like. The user apparatus 300A in FIG. 4 as an example has a communication unit 302, a control unit 304, and a storage unit 306. The communication unit 302 and the storage unit 306 of the user apparatus 300A are the same as the communication unit 202 and the storage unit 206 of the server apparatus 200, respectively. However, the communication unit 202 may have a communication interface capable of receiving a signal from the sensing device SWS, for example, Bluetooth low energy (BLE) (R). In this configuration example, the user apparatus 300 can receive a signal from the sensing device SWS of an electronic cigarette having BLE. Furthermore, the user apparatus 300A has a display unit 308, an operation unit 310, and a position information acquisition unit 311. The display unit 308 is, for example, a liquid crystal display, an electroluminescence panel, or the like. The operation unit 310 may be, for example, a keyboard, a pointing device, or the like. More specifically, in this embodiment, the operation unit 310 includes a touch panel, and is practically integrated with the display unit 308. The position information acquisition unit 311 is provided with the same configuration as that of the position information acquisition unit 108, and transmits position information to the control unit 304.

The control unit 304 has a CPU and a main memory unit as in the control unit 204 of the server apparatus 200. The CPU of the control unit 304 executes the application program (application) 3061 stored in the storage unit 306. The application 3061 is a web browser or an application program for accessing information delivered from the server apparatus 200. The application 3061 has a GUI, receives an input from a user and a signal from the sensing device SWS described above, and transmits them to the server apparatus 200 via the network N. The user can provide information on a smoking history to the server apparatus 200 through the user apparatus 300. The user can obtain installation information and installation schedule information of a smoking unit SP and the like from the server apparatus 200 through the user apparatus 300.

Note that in FIG. 2, FIG. 3, and FIG. 4, the traveling units 100, the server apparatus 200, and the user apparatuses 300 are connected to one another via the same network N. However, this connection may be implemented using a plurality of networks. For example, the network connecting the traveling units 100 with the server apparatus 200 and the network connecting the server apparatus 200 with the user apparatuses 300 may be different networks.

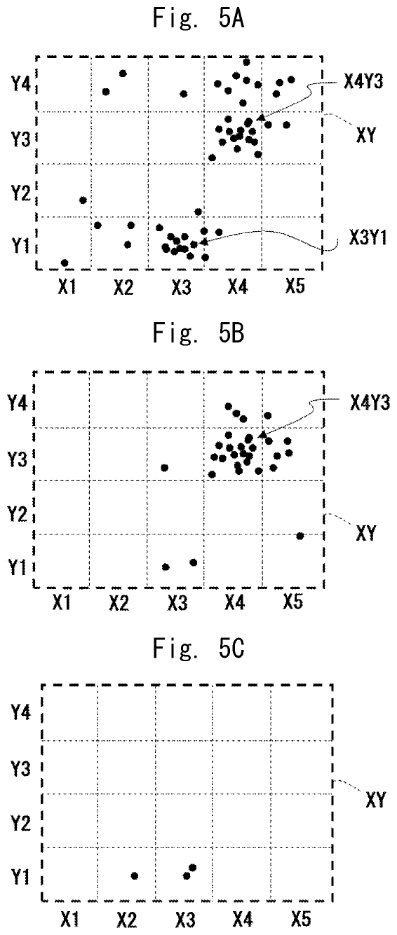

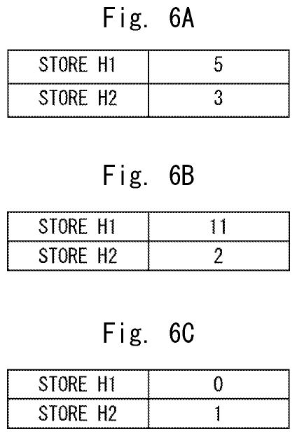

Here, the processing in the system S having the above-described configuration will be described based on FIG. 5 to FIG. 7 with reference to FIG. 1. First, the smoking-related information will be described based on FIG. 5 and FIG. 6. Note that FIG. 5 and FIG. 6 illustrate data on the same day.

FIG. 5A, FIG. 5B and FIG. 5C are diagrams representing the smoking service providing area XY (see FIG. 1) in the system S. As illustrated in FIG. 1, the area XY is divided into 20 pieces. It is divided into five units X1, X2, X3, X4, and X5 in the horizontal direction, and it is divided into four units Y1, Y2, Y3, and Y4 in the vertical direction. For example, the store H1 is located in the divided area in X5 and Y4, and the store H2 is located in the divided area in X2 and Y1. These symbols have the same order and arrangement as in FIG. 1.

FIG. 5A illustrates, in a plot, the locations of smoking histories in the area XY for a plurality of users in a morning time period (e.g., 6:00-12:00). FIG. 5B illustrates, in a plot, the locations of the smoking histories in the area XY for the plurality of users in an afternoon time period (e.g., 12:00-18:00). FIG. 5C illustrates, in a plot, the locations of the smoking histories in the area XY for the plurality of users in an evening time period (e.g., 19:00-6:00 next morning). These pieces of information are stored in the smoking-related information database 2063 of the storage unit 206 of the server apparatus 200. The demand estimation unit 2045 of the control unit 204 of the server apparatus 200 can find the possibility of smoking in the divided area X4Y3 in X4 and Y3 in the time period of 6:00-18:00 by analyzing data in FIGS. 5A-C according to a predetermined program. The demand estimation unit 2045 can find the possibility of smoking in the divided area X3Y1 in X3 and Y1 in the time period of 6:00-12:00. However, the definition of the time periods is not limited to the above, and they may be defined, for example, with a separator of every hour, every two hours, every three hours, every four hours, every half day, etc.

A procedure for obtaining the possibility of smoking as described above is as follows. For each divided area (Xi, Yj (in the case of FIG. 5, i is 1 to 5, and j is 1 to 4)), the number of demands (the number of smokers) per time period on a daily basis is predicted by regression analysis using time as an independent variable. However, another factor such as information on weather, each month of the year, and a season may be added as an independent variable. Such analysis makes it possible to predict how many demands (smokers) are present in a certain time period on a day depending on the season (or month), forecasted weather, and the like.

FIG. 6A, FIG. 6B and FIG. 6C illustrate cigarette purchase histories of a plurality of registered users at each of the store H1 and the store H2 in the area XY in each time period. Each table in FIG. 6 stores, in a pair, identification information of the stores H1 and H2 and the like and cigarette purchase histories of a plurality of users at each store. The cigarette purchase histories of the plurality of users here represent the number of registered users who made a purchase, and the numbers in FIG. 6 indicate the numbers of persons. The locations of the stores H1 and H2 are as illustrated in FIG. 1, and the server apparatus 200 records the latitudes and longitudes, addresses, and the like in a database in association with the identification information of the stores H1 and H2. FIG. 6A is a table in a morning time period (e.g., 6:00-12:00), FIG. 6B is a table in an afternoon time period (e.g., 12:00-18:00), and FIG. 6C is a table in an evening time period (e.g., 19:00-6:00 next morning). Accordingly, it can be said that a cigarette purchase history has position information and time information of purchase of cigarettes. The demand estimation unit 2045 of the control unit 204 of the server apparatus 200 analyzes the data in FIGS. 6A-C according to a predetermined program to estimate the possibility of smoking in all the divided areas in the area XY. For example, the number of demands (the number of smokers) per time period on a daily basis is predicted by regression analysis using the number of times of selling cigarettes, the number of purchasers, and the like per time period at each store as independent variables, based on a sampling number for the number of smokers per time period in each divided area. Then, it is sufficient for the demand estimation unit 2045 to determine that demand is present when the number of demands (the number of smokers) is larger than or equal to a reference value. However, deep learning may be performed using the number of times of selling cigarettes, the number of purchasers, and the like per time period at each store as an input vector, and using a sampling number for the number of smokers per time period in each divided area as supervised data. Then, it is sufficient to use weight data acquired in the learning network to output, in the recognition network, an estimate of the number of smokers (or a result of determining that the number is large, the number is small, demand is present, demand is absent, etc.) per time period in each divided area.

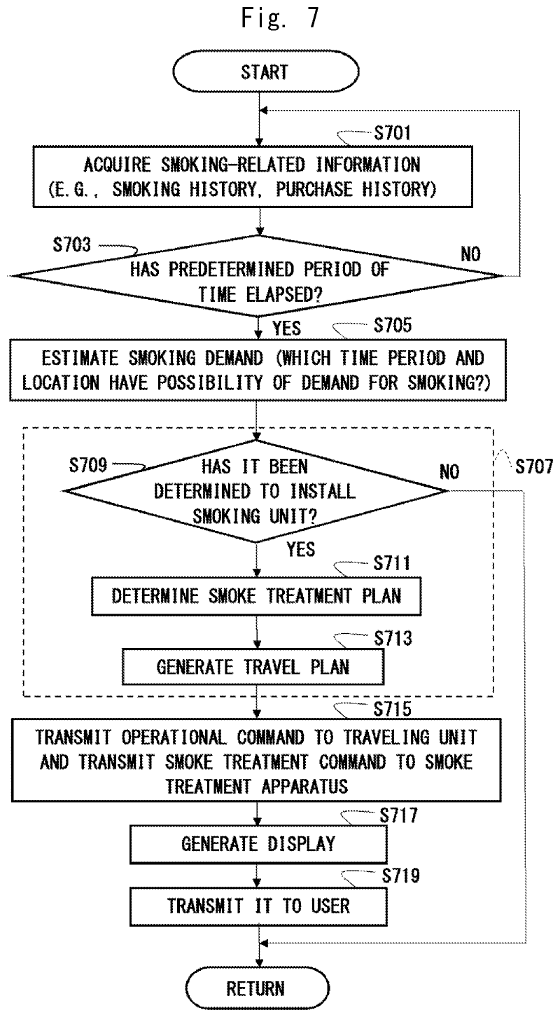

Based on the above description of FIG. 5 and FIG. 6, the processing in the server apparatus 200 in the system S will further be described based on a flowchart in FIG. 7.

When acquiring information on a smoking history from the user apparatus 300 or acquiring information on a cigarette purchase history from the computers HC1 and HC2 in the stores H1 and H2, the information acquisition unit 2041 of the server apparatus 200 transmits them to the smoking management unit 2044 (step S701). Then, the smoking management unit 2044 stores those pieces of information in the smoking-related information database 2063 as the smoking-related information. This is continuously performed until a predetermined period of time has elapsed (until positive determination is made in step S703). For example, this predetermined period of time may be one day, one week, or one month. Here, the following description will be given assuming that this predetermined period of time is one day.

When the predetermined period of time has elapsed (positive determination in step S703), the demand estimation unit 2045 of the server apparatus 200 estimate time periods and locations having the possibility of smoking (step S705). As already described based on FIG. 5 and FIG. 6, for example, the divided area X4Y3 in the time period of 6:00-18:00 and the divided area X3Y1 in the time period of 6:00-12:00 are estimated here as time periods and locations having the possibility of smoking.

After the processing of estimating time periods and locations having the possibility of smoking, the command generation unit 2046 of the server apparatus 200 is activated (step S707). First, as the first stage, the installation determination unit 2046a determines in which time period a smoking unit SP, that is, a smoking space is installed at one or a plurality of locations among the estimated time periods and locations having demand for smoking (step S709). Especially here, it is determined whether there is any hindrance to installation of a smoking unit SP with respect to the estimated locations and time periods. Specifically, a location satisfying a condition that there is no existing smoking facility is determined as a location for installing a smoking unit SP. Here, as illustrated in FIG. 1, a smoking place A is provided in the divided area X3Y1 as an existing smoking facility. Accordingly, a smoking unit SP is not installed in the divided area X3Y1 in the time period of 6:00-12:00, but it is determined to install a smoking unit SP only in the divided area X4Y3 in the time period of 6:00-18:00. The above processing is an example of generating a travel plan based on whether an existing smoking facility is present or absent.

Note that when it cannot be determined to install a smoking unit SP (negative determination in step S709), the routine ends. When any time period and location having the possibility of smoking cannot be estimated in step S705, negative determination is also made in step S709.

A smoke treatment plan is determined by the smoke treatment unit 2046b in the command generation unit 2046 for the smoking unit SP that is determined to be installed in the divided area X4Y3 in the time period of 6:00-18:00 (step S711). In this embodiment, a predetermined condition permitting smoke exhaust in this smoking unit SP is satisfied only when the smoking unit SP is in the treatment site E. So here, for the smoking unit SP determined to be installed in the divided area X4Y3 in the time period of 6:00-18:00, it is determined to move the smoking unit SP to the treatment site E in the process of retrieval as the smoke treatment plan. Note that when any location or the like that satisfies the predetermined condition permitting smoke exhaust cannot be found, it is determined that smoke treatment is not performed until reaching a standby position in the center C.

Then, a travel plan for installing a smoking unit SP in the divided area X4Y3 in the time period of 6:00-18:00 is generated including this smoke exhaust plan by the plan generation unit 2046c in the command generation unit 2046 (step S713). Here, since the availability of the traveling units 100 can be confirmed with reference to the vehicle information database 2061 of the storage unit 206, the traveling unit 100A is determined as a traveling unit that is connected to a smoking unit SPA and moved and that is suitable for the divided area X4Y3. Then, a travel plan including the three plans below is generated. The first plan is one in which the traveling unit 100A is connected to the smoking unit SPA, and is moved to and detached at a predetermined position in the divided area X4Y3 by 6:00. The second plan is one in which the traveling unit 100A is connected to the smoking unit SPA at 18:00, and is moved to the treatment site E. The third plan is one in which the traveling unit 100A performs exhaust processing of air containing smoke and the like at the treatment site E, then returns to the center C, and puts the smoking unit SPA in a standby state. Note that the route R1 in FIG. 1 corresponds to the first plan, the route R2 in FIG. 1 corresponds to the second plan, and the route R3 in FIG. 1 corresponds to the third plan.

Thus, the command generation unit 2046 generates an operational command including the generated travel plan and a smoke treatment command (step S707). The thus-generated operational command is transmitted by the information providing unit 2048 to the traveling unit 100A (step S715). That is, the generated travel plan is transmitted to the traveling unit 100A as control information for automatic driving thereof.

The smoke treatment command is transmitted to the smoke treatment apparatus PE mounted on the smoking unit SPA (step S715). This causes the second control unit PE4 of the smoke treatment apparatus PE to perform purification of air containing smoke and exhaust processing of the purified air according to the smoke treatment command. However, when the traveling unit 100A is connected to the smoking unit SPA, the control unit 104 of the traveling unit 100A may pertain the smoke treatment and the exhaust processing through the second driving unit 111. In this case, it is sufficient that the smoke treatment command is transmitted to the traveling unit 100A. In any case, in the system S of this embodiment, the travel control of the traveling unit 100A with the operational command and the exhaust processing including the smoke treatment by the smoke treatment apparatus PE are performed in coordination with each other according to the travel plan and the smoke treatment plan.

Next, the display information generation unit 2047 of the server apparatus 200 generates information to be provided to the user apparatus 300 based on the travel plan included in the operational command as described above (step S717). Then, the generated information is transmitted by the information providing unit 2048 to the user apparatus 300 (step S719).

As describe above, in the above system S, estimating smoking demand based on past smoking-related information on a plurality of users is first performed by the control unit 204 in the server apparatus 200. Then, generating a travel plan for a traveling unit 100 with a smoking unit SP as a vehicle having a smoking space based on the estimated smoking demand is performed by the control unit 204. As a result, a traveling unit with a smoking unit is caused to travel according to the travel plan. Accordingly, it is possible to suitably provide a smoking space for smokers.

Note that in the above embodiment, a smoking unit SP is installed at a location and in a time period that have the possibility of smoking. However, it is possible to cause a traveling unit 100 with a smoking unit SP, that is, a vehicle to travel to a location and in a time period that have the possibility of smoking, there allow users who are smokers to get in its smoking space, and then cause the vehicle to travel with the users getting thereon.

The above embodiment is merely an example, and the present disclosure may be appropriately modified and implemented within the scope of not deviating from its spirit. The processes and/or means described in the present disclosure can be implemented by taking a part of them, or can be implemented in any combination as long as there is no technical contradiction. The order of the steps described in FIG. 7 allows orders other than the order.

A process that has been described as performed by one apparatus may be shared and performed by a plurality of apparatuses. For example, the server apparatus 200 which is an information processing apparatus and/or the information processing apparatus 102 of the traveling unit 100 are each not necessarily one computer, but may be configured as a system provided with a plurality of computers. Alternatively, processes that have been described as performed by different apparatuses may be performed by one apparatus. In a computer system, it is flexibly modified what hardware configuration is used to implement each function.

The present disclosure can also be implemented by supplying a computer program implementing the functions described in the above embodiment to a computer, and allowing one or more processors of the computer to read and execute the program. Such a computer program may be provided to the computer through a non-transitory computer readable storage medium that is connectable to a system bus of the computer, or may be provided to the computer via a network. Non-transitory computer readable storage media include, for example, any type of disk such as a magnetic disk (e.g., floppy (R) disk, hard disk drive (HDD)), an optical disc (e.g., CD-ROM, DVD disc, blu-ray disc), a read-only memory (ROM), a random access memory (RAM), an EPROM, an EEPROM, a magnetic card, a flash memory, an optical card, and any type of medium suitable for storing electronic instructions.

What is claimed is:

1. An information processing apparatus comprising a controller including at least one processor configured to perform:
estimating smoking demand based on past smoking-related information on a plurality of users; and
generating a travel plan for a vehicle including a smoking space based on the estimated smoking demand.

2. The information processing apparatus according to claim 1, wherein
the smoking-related information includes at least any one of a smoking history and a cigarette purchase history of the plurality of users.

3. The information processing apparatus according to claim 2, wherein
the smoking history has position information and time information of smoking.

4. The information processing apparatus according to claim 2, wherein the controller performs
acquiring the smoking history based on a signal from a user apparatus of a user who is a smoker that senses activation of a switch of an electronic cigarette.

5. The information processing apparatus according to claim 2, wherein
the cigarette purchase history has position information and time information of purchase of a cigarette.

6. The information processing apparatus according to claim 1, wherein
estimating the smoking demand includes estimating a time period and a location including a possibility of smoking.

7. The information processing apparatus according to claim 1, wherein
generating the travel plan is performed based on whether an existing smoking facility is present or absent.

8. The information processing apparatus according to claim 1, wherein
the vehicle comprises a smoking unit provided with the smoking space, and a traveling unit to which the smoking unit is separably connected.

9. The information processing apparatus according to claim 8, wherein
the travel plan includes a separation position and a separation time of the smoking unit from the traveling unit, and a retrieval time at which the separated smoking unit is connected to the traveling unit.

10. The information processing apparatus according to claim 8, wherein the controller further performs
transmitting the generated travel plan as control information for automatic driving of the traveling unit.

11. The information processing apparatus according to claim 1, wherein
the vehicle comprises a smoke treatment apparatus, and
the controller further performs
activating the smoke treatment apparatus to allow smoke to be exhausted to outside of the vehicle when a predetermined condition permitting smoke exhaust is satisfied.

12. The information processing apparatus according to claim 1, wherein the controller further performs
displaying, on a user apparatus of a user, at least one of a current arrangement map of the smoking space and information specifying a scheduled date and time at which the smoking space is arranged at a position within a predetermined range from a position of the user apparatus.

13. An information processing method, wherein at least one computer performs:
estimating smoking demand based on past smoking-related information on a plurality of users; and
generating a travel plan for a vehicle including a smoking space based on the estimated smoking demand.

14. The information processing method according to claim 13, wherein
the smoking-related information includes at least any one of a smoking history and a cigarette purchase history of the plurality of users.

15. The information processing method according to claim 13, wherein
estimating the smoking demand includes estimating a time period and a location including a possibility of smoking.

16. The information processing method according to claim 13, wherein
generating the travel plan is performed based on whether an existing smoking facility is present or absent.

17. The information processing method according to claim 13, wherein:
the vehicle comprises a traveling unit separably connected to a smoking unit provided with the smoking space; and
the travel plan includes a separation position and a separation time of the smoking unit from the traveling unit, and a retrieval time at which the separated smoking unit is connected to the traveling unit.

18. The information processing method according to claim 17, wherein the at least one computer further performs
transmitting the generated travel plan as control information for automatic driving of the traveling unit.

19. The information processing method according to claim 13, wherein the at least one computer further performs
displaying, on a user apparatus of a user, at least one of a current arrangement map of the smoking space and information specifying a scheduled date and time at which the smoking space is arranged at a position within a predetermined range from a position of the user apparatus.

20. A system comprising:
an information processing apparatus comprising a controller including at least one processor configured to perform:
estimating smoking demand based on past smoking-related information on a plurality of users; and
generating a travel plan for a vehicle including a smoking space based on the estimated smoking demand; and
the vehicle.
